(19) United States
(12) Patent Application Publication
(10) Pub. No.: US 2007/0285496 A1
(43) Pub. Date: Dec. 13, 2007

(54) System and method for fast video call setup based upon earlier provided information

(75) Inventor: Lasse Leva, Ruutana (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/447,784

(22) Filed: Jun. 6, 2006

(51) Int. Cl. H04N 7/14; H04M 11/00

(52) U.S. Cl. 348/14.01; 379/102.03

(57) ABSTRACT

A system and method for accelerating the rate at which a video call can be setup between two devices. When a video call is initiated for the first time between two mobile devices, information regarding what type of multiplex entries and logical channels are used for video calls between these devices is stored. This information is used when a second video call is established between these devices. In a second or other subsequent video call, a number of steps in the setup process can be skipped, as each device instead uses information obtained from the initial video call.

### FIELD OF THE INVENTION

The present invention relates generally to video calls conducted between users. More particularly, the present invention relates to the process for establishing video calls between users.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

In recent years, important developments and improvements have been made in the establishing and conducting of “video calls,” which are similar to conventional telephone calls in several respects, except that the users also receive video from the other party in addition to audio. As communication and data transfer technology continues to advance, more and more people will expect and in fact rely on having the ability to place and receive video calls with other users around the world.

Currently, video calls involving mobile devices (such as mobile telephones) are established in substantially the same manner each time a call is initiated. The first step in this process involves a terminal capability set (TCS) exchange, where each device informs the other device of its capabilities, and master-slave device (MSD) negotiation. After successful TCS exchange and MSD negotiation, multiplex entries can be exchanged, and logical channels for audio and video can be opened. Once logical channels are opened and corresponding acknowledgements are received from the respective peer devices, data transfer can be initiated.

Unfortunately, the video call procedure discussed above takes a significant amount of time to complete. The terminal capability set exchange, master-slave negotiation, multiplex entry exchange and opening of logical channels requires at least two round trip delays and results in a lag between the time a call initiation is attempted and the time that actual communication between users can begin.

In light of the delay that occurs in conjunction with the establishing of conventional video calls, a number of attempts have been made to reduce this delay. One such attempt involves the use of WNSRP. WNSRP is a new standard developed by a consortium of third generation (3G) equipment solution providers. WNSRP reduces the time needed for video call setup by effectively eliminating message queuing and “time out” issues that occurred in conventional call setup procedures. However, WNSRP does not reduce the video call setup time by a significant amount, and it would therefore be desirable to implement a system and method that serves to further reduce the video call setup time.

### SUMMARY OF THE INVENTION

The present invention comprises a system and method for accelerating the rate at which a video call can be setup between two devices. When a video call is initiated for the first time between two mobile devices, TCS and MSD are performed in a conventional manner. In this arrangement, both devices receive the other peer device's TCS, and the master device for the call is decided based upon the MSD of the devices. Both devices also know, after transmission of the multiplex entry requests/acknowledgements and the opening of logical channels, what type of multiplex entries and logical channels are used for video calls between these devices. This information is used when a second video call is established between these devices. In a second or other subsequent video call, the TCS, MSD, multiplex entry (ME) and open logical channel (OLC) setup process can be skipped, as each device instead uses values obtained from the initial video call. Under various embodiments of the present invention, only OLC acknowledgments (acks) are sent in order to inform the other peer device that data can be transmitted. Both peer devices can transmit information to the other device as long as they have the other device's information saved to memory. This process can be performed in a manner similar to how multiplex (MUX) level setup is performed. As a result of the saving of this information, the time needed for the setup of subsequent video calls can be significantly reduced. The present invention can be used in conjunction with virtually any type of mobile device that can implement video call technology.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a perspective view of a mobile telephone that can be used in the implementation of the present invention;

FIG. 2 is a schematic representation of the telephone circuitry of the mobile telephone of FIG. 1;

FIG. 3 is a representation showing the process by which first and second peer terminals set up a video call with each other for the first time according to various embodiments of the present invention; and

FIG. 4 is a representation showing the process by which the first and second peer terminals set up a second or other subsequent video call with each other according to various embodiments of the present invention.

### DETAILED DESCRIPTION OF THE PREFERRED EMBODIMENTS

The present invention comprises a system and method for accelerating the rate at which a video call can be setup between two devices. When a video call is initiated for the first time between two mobile devices, TCS and MSD are performed in a conventional manner. In this arrangement, both devices receive the other peer device's TCS, and the master device for the call is decided based upon the MSD of the devices. Both devices also know, after transmission of the multiplex entry requests/acknowledgements and the opening of logical channels, what type of multiplex entries and logical channels are used for video calls between these devices. This information is used when a second video call is established between these devices. In a second or other subsequent video call, the TCS, MSD, ME and OLC setup process can be skipped, as each device instead uses values obtained from the initial video call. Under various embodiments of the present invention, only OLC acknowledgments are sent in order to inform the other peer device that data can be transmitted. Both peer devices can transmit information to the other device as long as they have the other device's information saved to memory.

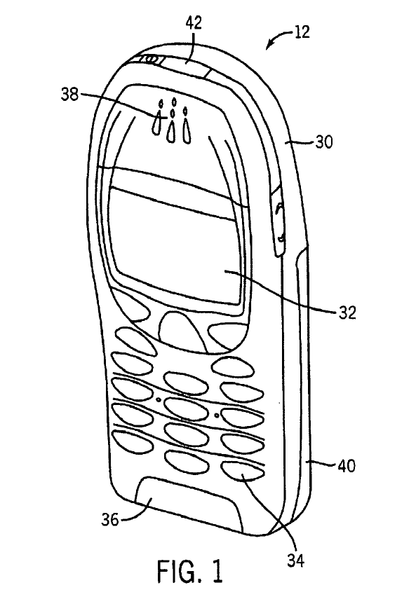

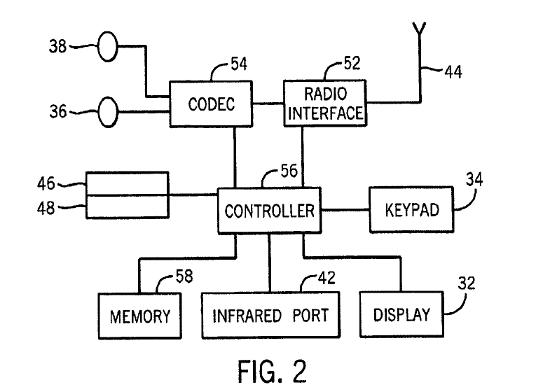

FIGS. 1 and 2 show one representative mobile telephone 12 which can be used in conjunction with the implementation of the present invention. It should be understood, however, that use the present invention is not intended to be limited to one particular type of mobile telephone 12 or other electronic device. The mobile telephone 12 of FIGS. 1 and 2 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

Communication devices that can be used in conjunction with the present invention may be capable of communicating using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

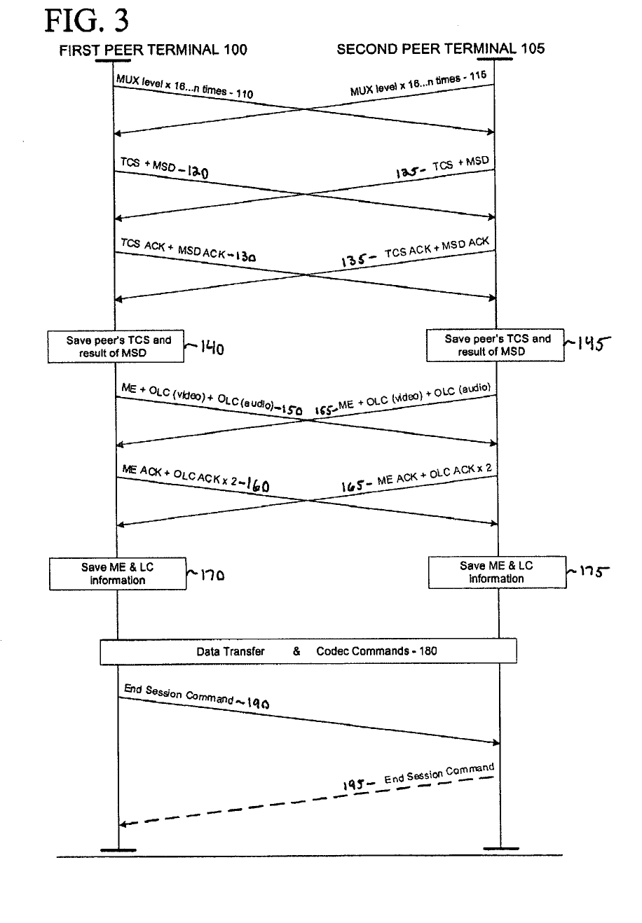

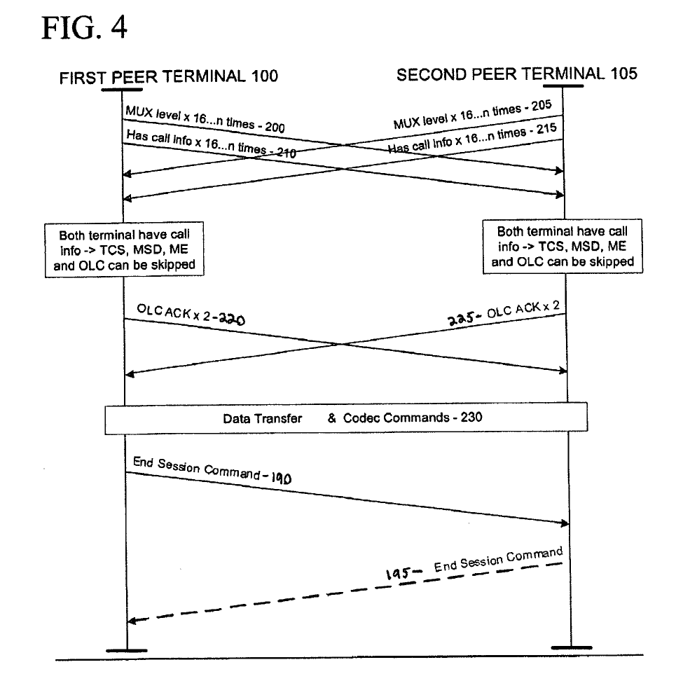

FIGS. 3 and 4 show the process by which a first peer terminal 100 and a second peer terminal 105 set up a first and subsequent video calls between each other according to various embodiments of the present invention. FIG. 3 shows the set up process for a first video call between the first peer terminal 100 and the second peer terminal 105. At 110 in FIG. 3, the first peer terminal 100 transmits its MUX level information to the second peer terminal 105. Similarly, at 115 the second peer terminal 105 transmits its MUX level information to the first peer terminal 100. At 120, the first peer terminal 100 transmits TCS information and MSD negotiation information to the second peer terminal 105. Similarly, at 125 the second peer terminal 105 transmits its own TCS information and MSD negotiation information to the first peer terminal 100. At 130, the first peer terminal 100 transmits an acknowledgement of receipt of the second peer terminal's TCS and MSD negotiation information. The second peer terminal 105 transmits a similar acknowledgement at 135. Once these acknowledgments are received and negotiation is completed, the first peer terminal 100 saves the second peer terminal's TCS and result of MSD at 140, and the second peer terminal 105 saves the first peer terminal's TCS and result of MSD at 145.

At 150 in FIG. 3, the first peer terminal 100 transmits ME information, as well as OLC information for both audio and video, to the second peer terminal 105. The second peer terminal 105 transmits its own such information to the first peer terminal 100 at 155. The transmitted ME and OLC information are used by the first and second peer terminals 100 and 105 to determine ME and logical channel information that is to be used during the data transfer process of the video call. The first peer terminal 100 acknowledges receipt of the second peer terminal's ME and OLC information at 160, and the second peer terminal 105 acknowledges receipt of the first peer terminal's ME and OLC information at 165. Once these acknowledgments are received, the first peer terminal 100 saves the ME and logical channel information to be used during data transfer at 170, and the second peer device saves the ME and logical channel information to be used during data transfer at 175. At 180, data transfer is conducted between the first and second peer terminals 100 and 105, and codec commands are also transferred. This is where the video call is actually conducted. When a user desires to terminate the video call, one of the peer terminals transmits an “end session” command at 190, which is acknowledged at 195.

FIG. 4 shows the call setup process for a subsequent video call. At 200, the first peer terminal 100 transmits its MUX level to the second peer terminal 105. Likewise, the second peer terminal 105 transmits its MUX level to the first peer terminal 100 at 205. At 210, the first peer terminal 100 transmits a message to the second peer terminal 105 indicating that it already has call information, namely, TCS, MSD, ME and OLC information, from the first video call between the two devices. The second peer terminal 105 transmits its own message of this type at 215. As a result of the two terminals having this information on hand, this information does not have to be resent during this setup process. At 220, the first peer terminal 100 sends an OLC acknowledgment to the second peer terminal 105. Similarly, at 225 the second peer terminal 105 sends and OLC acknowledgment to the first peer terminal 100. Once these acknowledgments are received, data transfer can be initiated and codec commands can be exchanged at 230. Like in FIG. 3, when a user desires to terminate the video call, one of the peer terminals transmits an “end session” command at 190, which is acknowledged at 195.

Because, during subsequent video calls, only OLC acknowledgments are sent to the other peer terminal (to inform the other peer terminal that video and audio transmission can be started), the time needed for call setup is greatly reduced. In fact, at least a one and a half round trip delays are effectively eliminated by having the TCS, MSC, ME and OLC information saved. In one embodiment of the invention, all of this information is saved in the memory of the respective peer terminals according to the other peer terminal's telephone number.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of using a first peer terminal to establish a video call with a second peer terminal, comprising:
transmitting first multiplex-related information to the second peer terminal;
transmitting to the second peer terminal a first indication that the first peer terminal is in possession of call information for the second peer terminal necessary to establish the video call;
receiving second multiplex-related information from the second peer terminal;
receiving from the second peer terminal a second indication that the second peer terminal is in possession of call information for the first peer terminal necessary to establish the video call;
transmitting a first open channel acknowledgement to the second peer terminal; and
receiving a second open channel acknowledgment from the second peer terminal.

2. The method of claim 1, wherein the call information for the second peer terminal is stored in a memory unit of the first peer terminal.

3. The method of claim 2, wherein the call information for the second peer terminal is identified by a telephone number for the second peer terminal.

4. The method of claim 1, wherein the call information for the second peer terminal includes at least one of terminal capability set information, master-slave device negotiation information, multiplex entry information and open logical channel information for the second peer terminal.

5. The method of claim 1, wherein the call information for the first peer terminal includes at least one of terminal capability set information, master-slave device negotiation information, multiplex entry information and open logical channel information for the second peer terminal.

6. The method of claim 1, further comprising, after transmitting the first open channel acknowledgement to the second peer terminal and receiving a second open channel acknowledgment from the second peer terminal, conducting data transfer with the second peer terminal.

7. A computer program product, embodied in a computer-readable medium, for using a first peer terminal to establish a video call with a second peer terminal, comprising:
computer code for transmitting first multiplex-related information to the second peer terminal;
computer code for transmitting to the second peer terminal a first indication that the first peer terminal is in possession of call information for the second peer terminal necessary to establish the video call;
computer code for receiving second multiplex-related information from the second peer terminal;
computer code for receiving from the second peer terminal a second indication that the second peer terminal is in possession of call information for the first peer terminal necessary to establish the video call;
computer code for transmitting a first open channel acknowledgement to the second peer terminal; and
computer code for receiving a second open channel acknowledgment from the second peer terminal.

8. The computer program product of claim 7, wherein the call information for the second peer terminal is stored in a memory unit of the first peer terminal.

9. The computer program product of claim 8, wherein the call information for the second peer terminal is identified by a telephone number for the second peer terminal.

10. The computer program product of claim 7, wherein the call information for the second peer terminal includes at least one of terminal capability set information, master-slave device negotiation information, multiplex entry information and open logical channel information for the second peer terminal.

11. The computer program product of claim 7, wherein the call information for the first peer terminal includes at least one of terminal capability set information, master-slave device negotiation information, multiplex entry information and open logical channel information for the second peer terminal.

12. The computer program product of claim 7, further comprising computer code for, after transmitting the first open channel acknowledgement to the second peer terminal and receiving a second open channel acknowledgment from the second peer terminal, conducting data transfer with the second peer terminal.

13. A first peer terminal with video call capability, comprising:
a processor; and
a memory unit communicatively connected to the processor and including:
computer code for transmitting first multiplex-related information to a second peer terminal;
computer code for transmitting to the second peer terminal a first indication that the first peer terminal is in possession of call information for the second peer terminal necessary to establish the video call;
computer code for receiving second multiplex-related information from the second peer terminal;
computer code for receiving from the second peer terminal a second indication that the second peer terminal is in possession of call information for the first peer terminal necessary to establish the video call;
computer code for transmitting a first open channel acknowledgement to the second peer terminal; and
computer code for receiving a second open channel acknowledgment from the second peer terminal.

14. The first peer terminal device of claim 13, wherein the call information for the second peer terminal is stored in the memory unit of the first peer terminal.

15. The first peer terminal device of claim 14, wherein the call information for the second peer terminal is identified by a telephone number for the second peer terminal.

16. The first peer terminal device of claim 13, wherein the call information for the second peer terminal includes at least one of terminal capability set information, master-slave device negotiation information, multiplex entry information and open logical channel information for the second peer terminal.

17. The first peer terminal device of claim 13, wherein the call information for the first peer terminal includes at least one of terminal capability set information, master-slave device negotiation information, multiplex entry information and open logical channel information for the second peer terminal.

18. The first peer terminal device of claim 13, wherein the memory unit further comprises computer code for, after transmitting the first open channel acknowledgement to the second peer terminal and receiving a second open channel acknowledgment from the second peer terminal, conducting data transfer with the second peer terminal.

19. A method of using a first peer terminal to establish a video call with a second peer terminal, comprising:
exchanging multiplex-related information with the second peer terminal;
exchanging terminal capability set information and master-slave device negotiation information with the second peer terminal;
exchanging multiplex entry information and open logical channel information with the second peer terminal; and
saving call information received from the second peer terminal for use in establishing a subsequent video call, the saved call information including the terminal capability set information, the master-slave device negotiation information, the multiplex entry information and the open logical channel information received from the second peer terminal.

20. The method of claim 19, wherein the saved call information is saved in a memory unit and is identified by a telephone number of the second peer terminal.

21. The method of claim 19, further comprising:
completing the video call with the second peer terminal; and
establishing a subsequent call with the second peer terminal, the establishing of the subsequent call including the use of the saved call information.

22. A computer program product, embodied in a computer readable medium, for using a first peer terminal to establish a video call with a second peer terminal, comprising:
computer code for exchanging multiplex-related information with the second peer terminal;
computer code for exchanging terminal capability set information and master-slave device negotiation information with the second peer terminal;
computer code for exchanging multiplex entry information and open logical channel information with the second peer terminal; and
computer code for saving call information received from the second peer terminal for use in establishing a subsequent video call, the saved call information including the terminal capability set information, the master-save device negotiation information, the multiplex entry information and the open logical channel information received from the second peer terminal.

23. The computer program product of claim 22, wherein the saved call information is saved in a memory unit and is identified by a telephone number of the second peer terminal.

24. The computer program product of claim 22, further comprising:
computer code for completing the video call with the second peer terminal; and
computer code for establishing a subsequent call with the second peer terminal, the establishing of the subsequent call including the use of the saved call information.

25. A first peer terminal with video call capability, comprising:
a processor; and
a memory unit communicatively connected to the processor and including:
computer code for exchanging multiplex-related information with the second peer terminal;
computer code for exchanging terminal capability set information and master-slave device negotiation information with the second peer terminal;
computer code for exchanging multiplex entry information and open logical channel information with the second peer terminal; and
computer code for saving call information received from the second peer terminal for use in establishing a subsequent video call, the saved call information including the terminal capability set information, the master-slave device negotiation information, the multiplex entry information and the open logical channel information received from the second peer terminal.

26. The first peer terminal device of claim 25, wherein the saved call information is saved in a memory unit and is identified by a telephone number of the second peer terminal.

27. The first peer terminal device of claim 25, wherein the memory unit further comprises:
computer code for completing the video call with the second peer terminal; and
computer code for establishing a subsequent call with the second peer terminal, the establishing of the subsequent call including the use of the saved call information.
